(19) United States
(12) Patent Application Publication
(10) Pub. No.: US 2003/0202102 A1
(43) Pub. Date: Oct. 30, 2003

(54) Monitoring system

(75) Inventors: Natsuko Shiota, Hirakata-Shi (JP); Masaaki Nakai, Suita-Shi (JP); Kyoko Nakamura, Toyonaka-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/400,342

(22) Filed: Mar. 27, 2003

(30) Foreign Application Priority Data
Mar. 28, 2002 (JP) 2002-91052
Mar. 28, 2002 (JP) 2002-91066

(51) Int. Cl. H04N 7/18

(52) U.S. Cl. 348/159; 348/699

(57) ABSTRACT

A monitoring system according to the present invention includes a camera; a display device for displaying a time-varying image captured by the camera; a switching section for switching a view on the display device from the time-varying image to a still image in response to a user command; a storage section for storing information regarding an object to be monitored, the object being selected by pointing at the object in the still image on the display device; and a detecting section for detecting the object in an image captured by the camera, based on the image and the information regarding the object to be monitored which is stored in the storage section.

### RELATED APPLICATIONS

This application is based on Japanese Patent Applications Nos. 2002-91052 and 2002-91066, each content of which being incorporated herein by reference.

### BACKGROUND OF THE INVENTION

1. Field of the Invention

The present invention relates to a monitoring system having a plurality of cameras. The present invention also relates to a program for controlling the monitoring system.

2. Description of the Related Art

A typical surveillance system installed in a place such as store includes a plurality of surveillance cameras. Each camera has an area to be monitored.

However, where an intruder is detected in a monitored area, since the system is generally designed so that only one surveillance camera is capable of viewing that area, there is a practical possibility that the image of the intruder's face could not be captured if the person showed his or her back to the camera.

In the meantime, there has been a demand for a monitoring camera that is capable of detecting a specific color and track it. Such camera, if installed, for example, at school or at a child care center, can detect an infant wearing specified color clothes who is about to enter a dangerous place or track a child wearing specified color clothes. In combination with a technology known as streaming video, this camera allows a parent in the office or at home to monitor what his or her child is doing.

In order to detect or track a specific color, the data thereof should be stored in advance in a memory of the monitoring system. Although a sample color may be used to specify a color, it would be difficult to select a sample color which corresponds to a color to be detected or tracked.

### SUMMARY OF THE INVENTION

The object of the present invention is to provide a monitoring system capable of imaging a location from a plurality of directions where something abnormal might have happened.

Another object of the present invention is to provide a monitoring system in which information regarding an object to be monitored (e.g. color information) can be easily specified or configured.

Another object of the present invention is to provide a computer program for controlling such monitoring systems.

To achieve the above object, a first aspect of the present invention is a monitoring system that includes first and second cameras for capturing an image of first and second areas, respectively; first and second detectors for detecting an object to be monitored or abnormality in the first and second areas, respectively; and a controller for controlling view fields of the first and second cameras. When the second detector detects the object or abnormality in the second area, the first camera is controlled so that it views the second area within its view field. When the first detector detects the object or abnormality in the first area, the second camera is controlled so that it views the first area within its view field.

An additional aspect of the present invention is a monitoring system that includes a camera; a display device for displaying a time-varying image captured by the camera; a switching section for switching a view on the display device from the time-varying image to a still image in response to a user command; a storage section for storing information regarding an object to be monitored, the object being selected by pointing at the object in the still image on the display device; and a detecting section for detecting the object in an image captured by the camera, based on the image and the information regarding the object to be monitored which is stored in the storage section.

The image used for a detection of an object to be monitored may be a still image frame or time-varying image frame.

A still further aspect of the present invention is a computer program for controlling a monitoring system comprising first and second cameras for capturing an image of first and second areas, respectively; and first and second detectors for detecting an object to be monitored or abnormality in the first and second areas, respectively. The computer program includes instructions for causing a computer to implement a method including controlling the first camera so that it views the second area within its view field when the second detector detects the object or abnormality in the second area; and controlling the second camera so that it views the first area within its view field when the first detector detects the object or abnormality in the first area.

A still further aspect of the present invention is a computer program for controlling a monitoring system comprising a camera and a display device for displaying a time-varying image captured by the camera. The computer program includes instructions for causing a computer to implement a method including switching a view on the display device from the time-varying image to a still image in response to a user command; storing information regarding an object to be monitored, the object being selected by pointing at the object in the still image on the display device; and detecting the object in an image captured by the camera, based on the image and the information regarding the object to be monitored.

### BRIEF DESCRIPTION OF THE DRAWINGS

These and other objects, advantages and features of the invention will become apparent from the following description thereof taken in conjunction with the accompanying drawings in which:

FIG. 1 is a schematic view of one embodiment of the monitoring system according to the present invention, the system including a plurality of camera;

FIG. 2 is a block diagram showing the monitoring system of FIG. 1;

FIG. 3A is a diagram showing a window on a display device upon a start-up of the system;

FIG. 3B is a diagram showing a display device screen indicating a configuration menu window;

FIG. 4A is a diagram showing a display device screen indicating images captured by the plurality of cameras, when the images are switched while display blocks assigned to the cameras are fixed;

FIG. 4B is a diagram showing a display device screen indicating images captured by the plurality of cameras, when the images are switched while display blocks assigned to monitored areas are fixed;

FIG. 5 is a diagram showing information managed by a main management section, the information being related to status of the plurality of cameras;

FIG. 6 is a block diagram of each camera;

FIG. 7 is a flow chart illustrating a monitoring/tracking operation carried out by the monitoring system of FIG. 1;

FIG. 8 is a flow chart illustrating the subroutine of the abnormality detection information verification in FIG. 7;

FIG. 9 is a flow chart showing a monitoring sequence of each camera;

FIG. 10 is a flow chart illustrating the subroutine of the intensive monitoring control in FIG. 7;

FIG. 11 is a flow chart illustrating the tracking subroutine in FIG. 7;

FIG. 12 is a flow chart showing a tracking sequence of each camera;

FIG. 13 is a diagram showing the switching of images on a screen of the display device in the process of the intensive monitoring control;

FIG. 14 is a flow chart illustrating another subroutine of the intensive monitoring control;

FIG. 15 is a schematic diagram showing the intensive monitoring control operation shown in FIG. 14 performed by the monitoring system according to the present invention;

FIG. 16 is a flow chart showing a configuration process of areas to be monitored;

FIG. 17 is a flow chart showing the subroutine in FIG. 16;

FIG. 18 is a flow chart showing a configuration process of an order in which each camera makes the circuit of and captures images of a plurality of areas within its field of view;

FIG. 19 is a flow chart showing a configuration process of a time parameter indicating how long each camera captures an image of each monitored area;

FIG. 20 is a first part of a flow chart showing a configuration process of a detection color;

FIG. 21 is a second part of a flow chart showing a configuration process of a detection color;

FIG. 22A is a diagram showing a screen display on the display device in the detection color configuration process, wherein a point on the view is selected with a cursor.

FIG. 22B is a diagram showing a screen display on the display device in the detection color configuration process, wherein the selected point is moved at the center of the view field;

FIG. 22C is a diagram showing a screen display on the display device in the detection color configuration process, wherein the image on the monitor is magnified so that it is centered about the selected point;

FIG. 23 is a first part of a flow chart showing another configuration process of a detection color;

FIG. 24 is a second part of a flow chart showing another configuration process of a detection color; and

FIG. 25 is a flow chart showing a setting procedure of a detection color during a circuit of the cameras, for the purpose of detecting an object having the set color during the circuit.

### DETAILED DESCRIPTION OF THE PREFERRED EMBODIMENTS

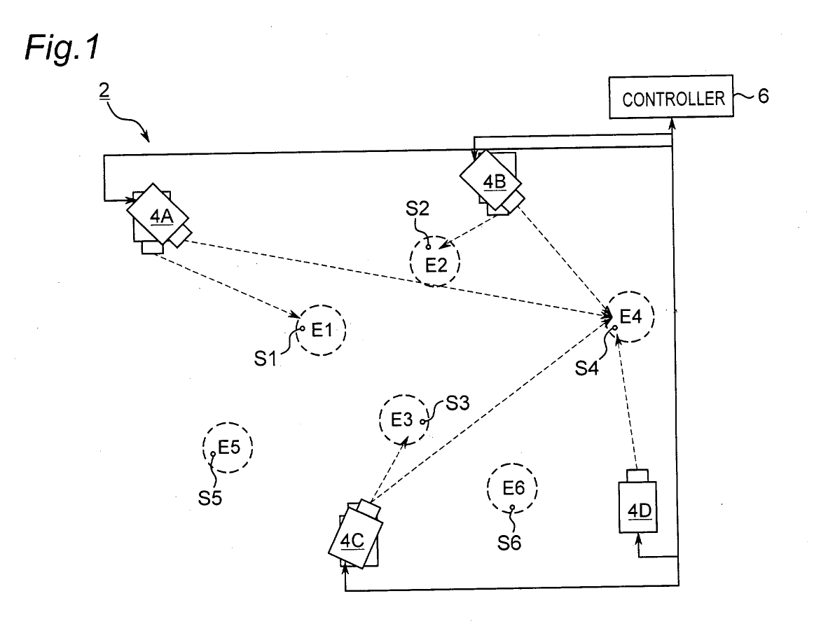

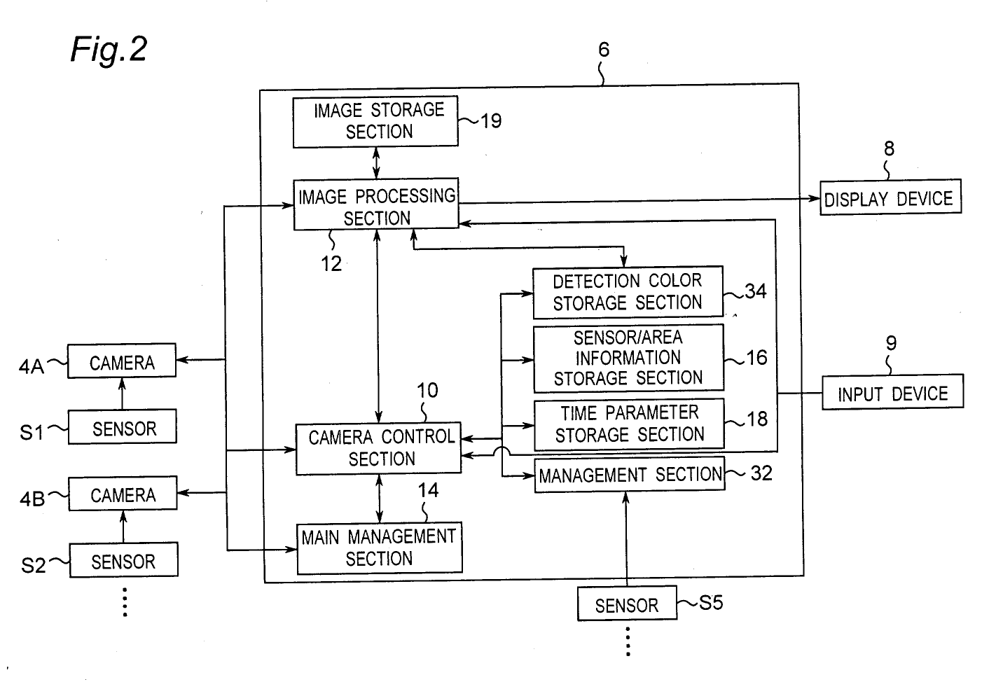

With reference to the drawings, a preferred embodiment of the present invention will be described hereinafter. Referring to FIGS. 1 and 2, there is shown a monitoring camera system 2 of one embodiment according to the present invention. The monitoring system 2 includes a plurality (four in the example shown) of camera units 4(4A, 4B, 4C and 4D) (which are hereinafter referred to as cameras) for making a circuit of and monitoring a plurality of areas E1-E4 and a controller (computer) 6 incorporating programs for enabling the plurality of cameras 4 to perform operations such as monitoring or tracking. Sensors S1-S4 are located in the areas to be monitored E1-E4, respectively. The system 2 also includes a display device 8 for displaying images simultaneously from the four cameras 4A-4D. An input device 9 such as keyboard or mouse is provided for inputting a user command into the controller 6. Each camera 4 is designed so that it selectively performs, in response to a command from the controller 6, a “normal” monitoring operation in which it monitors the areas E1-E4 in a predetermined order, an “intensive” monitoring operation in which all of the cameras 4 monitor an area intensively when an object to be monitored or abnormal status has been detected in the area, and a tracking operation in which the cameras 4 track an object which might have caused the abnormality. These operations will be described in detail.

The controller 6 includes a camera control section 10 for controlling a field of view of each camera 4 and an image processing section 12 for processing image data transmitted from the cameras 4. The controller 6 also includes a main management section 14 for managing information regarding status of the plurality of the cameras 4 and a storage section 16 for storing information on a positional relationship between the monitored areas E1-E4 and sensors S1-S4 (e.g. the sensor S3 is located in the area E3.). The controller 6 further includes a storage section 18 for storing various time parameters specified via the input device 9 by the user. The time parameter includes monitoring, tracking or scanning time parameters, which will be described below. The image data transmitted from the cameras 4 to the image processing section 12 is stored in an image storage section 19. Based on the data in the image storage section 19, image data is transmitted from the image processing section 12 to the display 8.

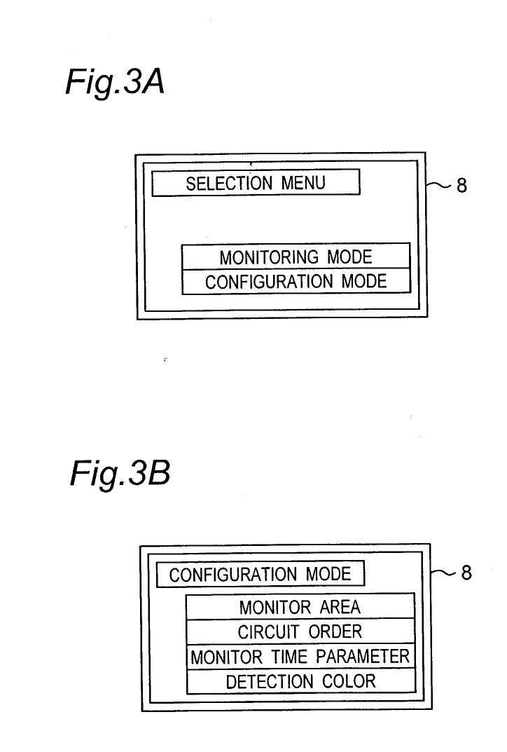

As shown in FIG. 3A, a selection menu window is displayed on the display device 8 upon a start-up of the system. The user may select either a monitoring mode that allows the system 2 to perform a monitoring operation or a configuration or setting mode that allows the parameters of the system 2 to be set in the selection menu window. As shown in FIG. 3B, the configuration mode window provides plural menus available to the user such as “Monitor Area”, “Circuit Order”, “Monitor Time Parameter” or “Detection Color.” In the “Monitor Area” menu, the user selects any location as an area to be monitored and sets a field of view of each camera 4 so that the camera captures an image of the set area. In the “Circuit Order” menu, the user selects an order in which each camera 4 makes the circuit of the plurality of monitored areas. In the “Monitor Time Parameter” menu, the user specifies a time parameter indicating how long each camera monitors each monitored area. In the “Detection Color” menu, the user selects a color to be detected in case where a color detection method is used to detect abnormality. The configuration mode will be described below in greater detail.

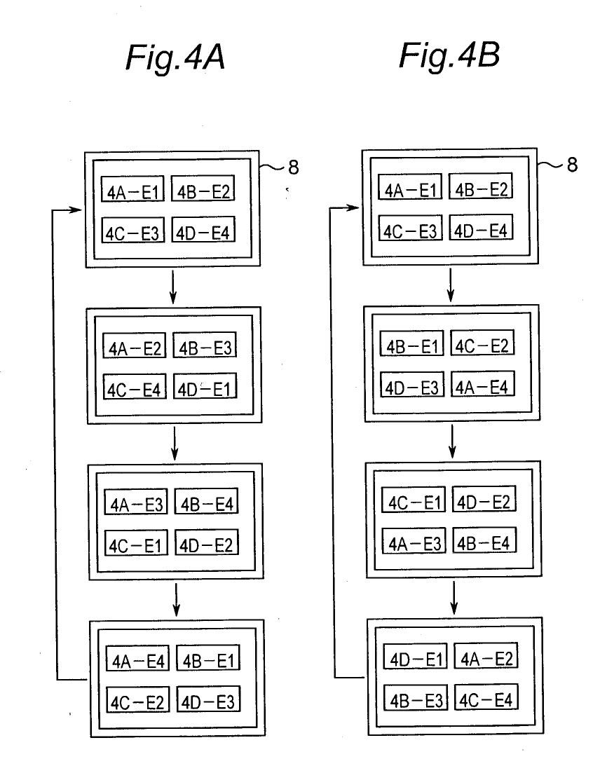

In the monitoring mode, the four images captured by the cameras 4A-4D are displayed on the four display blocks of the display device 8, as shown in FIGS. 4A and 4B. The images displayed on the divided blocks may be switched while the display blocks for the cameras are fixed as in FIG. 4A (e.g., the image captured by the camera 4A is always displayed on the upper left display block.). Alternatively, the display blocks for the monitored areas may be fixed as in FIG. 4B (e.g., the image of the monitored area E1 is always displayed on the upper left display block.). In this embodiment, the cameras are controlled in synchronism with each other so that they do not monitor the same monitored area(s) at the same time. However, the cameras may be controlled independently of each other.

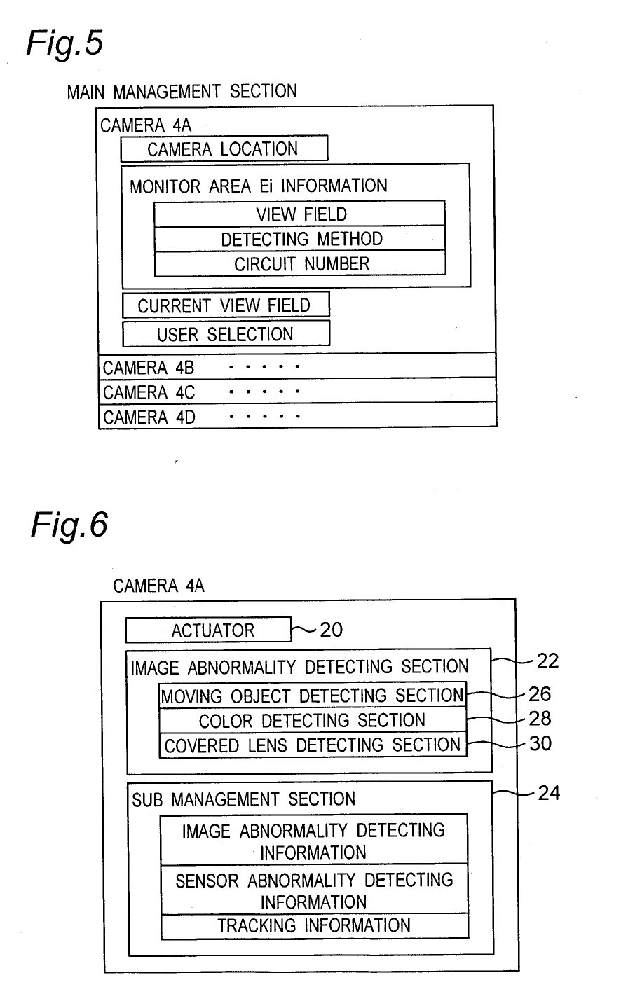

As shown in FIG. 5, the main management section 14 manages information per camera 4. The information includes a location of the camera 4 in the system, information regarding each monitored area Ei(i=1−4), a current field of view of the camera 4 and an user selection as to whether the camera 4 is selected via the input device 9, which will be described below. The information regarding the monitored area Ei includes a field of view within which the camera 4 views the area Ei, a surveillance or detecting method for detecting abnormality in the area Ei and a circuit number “n” (n=1−4) that represents the order in which the monitored area Ei is monitored during the circuit (e.g., the area E3 is the “2”nd to be pointed at by the camera 4A per cycle.). The view field within which each camera 4 views the monitored area Ei is determined in the configuration mode, as will be described below. A moving object detection is selected as the detecting method as long as the user does not select a color to be detected in the “Color Detection” menu.

Each camera 4 is a pan, tilt and zoom camera capable of tracking an object. Referring to FIG. 6, the camera 4 includes an actuator 20 for controlling its field of view (i.e. pan/tilt angles or orientation and magnification) in response to a signal from the camera control section 10 and a detecting section 22 for detecting abnormality in images captured by the camera 4. The camera 4 also includes a sub management section 24 for managing information on the camera 4. Each camera 4 is provided with an input terminal (not shown) to receive a detection signal from one of the sensors S1-S4 located in the monitored area E1-E4. The detection signal that is inputted in the terminal of the camera is transmitted to the sub management section 24. Alternatively, the sensor detection signal may be directly transmitted to the camera control section 10. In the example shown in FIG. 1, a signal is transmitted from the sensors S1-S4 to the camera 4A-4D, respectively.

The image abnormality detecting section 22 includes a detecting section 26 for detecting a moving object based on the difference between two image frames, a detecting section 28 for detecting a color which has been specified in the configuration mode in an image and a detecting section 30 for detecting it when a lens of the camera 4 is covered with something.

The sub management section 24 of each camera 4 manages information such as “image abnormality detection information” as to whether the image abnormality detecting section 22 has detected abnormality, “sensor abnormality detection information” as to whether a sensor S that transmits a detection signal to the camera 4 has detected abnormality, “tracking information” as to whether the camera is in a tracking operation, etc. As described below, the camera control section 10 checks this information, when necessary.

One or more sensors may be provided outside the monitored areas, i.e., within the area(s) that are not monitored by any cameras 4 during the normal circuit. In the example shown in FIG. 1, sensors S5 and S6 are located in the “outside” area E5 and E6, respectively. The sensor(s) such as S5 or S6 are referred to as “outside sensors” hereinafter. Where abnormality is detected in such area, it is intensively monitored by the cameras 4. With regard to the outside sensors, the controller 6 includes a management section 32 (FIG. 2) for managing “outside sensor abnormality detection information” as to whether an outside sensor has detected abnormality.

The input device 9 includes keys (not shown) for specifying various settings in configuration mode. In particular, the input device 9 includes plural keys (not shown) for configuring or setting a detection color such as a selection key with which a user can select a camera used for setting a detection color, a switching key with which a view on the display 8 is switched from a time-varying image to a still image, a decision/cancellation key with which the user can set a “pre-specified” color as detection color and/or cancel the decision and a mouse for moving a cursor on the screen of the display 8. The image processing section 12 is designed so that, when a user selects one of the cameras via the selection key, only an enlarged time-varying image captured by the selected camera is displayed on the display device 8. A consequent press of the switching key causes the image processing section 12 to switch a view on the display device 8 from the time-varying image to a still image. By consequently selecting any point in the still image with the cursor and then clicking a button of the mouse, a portion having a color on the selected point and its “approximate color” blinks or flashes. A press of the decision key causes the selected color and a color approximate to the selected color to be set as detection color and stored in a storage section 34 (FIG. 2) of the controller 6.

The time-varying image data and still image data are digital data that are represented, for example, in a YUV format, wherein 8 bits are assigned to each color of YUV and each color is represented on a scale from 0-255 (i.e., 256 gray levels). The image processing section 12 is configured so that it extracts color data related to pixels (e.g. 10 pixels) at the periphery of the point selected with the cursor. The image processing section 12 causes the color data, together with the data of the approximate color to be stored as detection color data in the detection color storage section 34. For example, where YUV data of a point selected with the cursor is represented in (Y,U,V)=(150, 70, 80), the image processing section 12 calculates the upper and lower limits with a predetermined “approximate width” of 30, i.e., Y:(135,165), U:(55,85) and V:(65,95), to be stored in the detection color storage section 34. It is noted here that other format such as RGB format may be used instead of the YUV format.

The selection key of the input device 9 is also used for a user, watching an image on the display 8, to transmit a signal to the camera control section 10 indicative of an area the image of which is captured by one camera to be monitored intensively. As described below, the camera control section 10 then controls the other cameras to capture an image of the area. The input device 9 is further used for a user to set parameters in the configuration mode. Furthermore, the input device 9 includes a stop key for terminating monitoring or tracking operations in the monitoring mode.

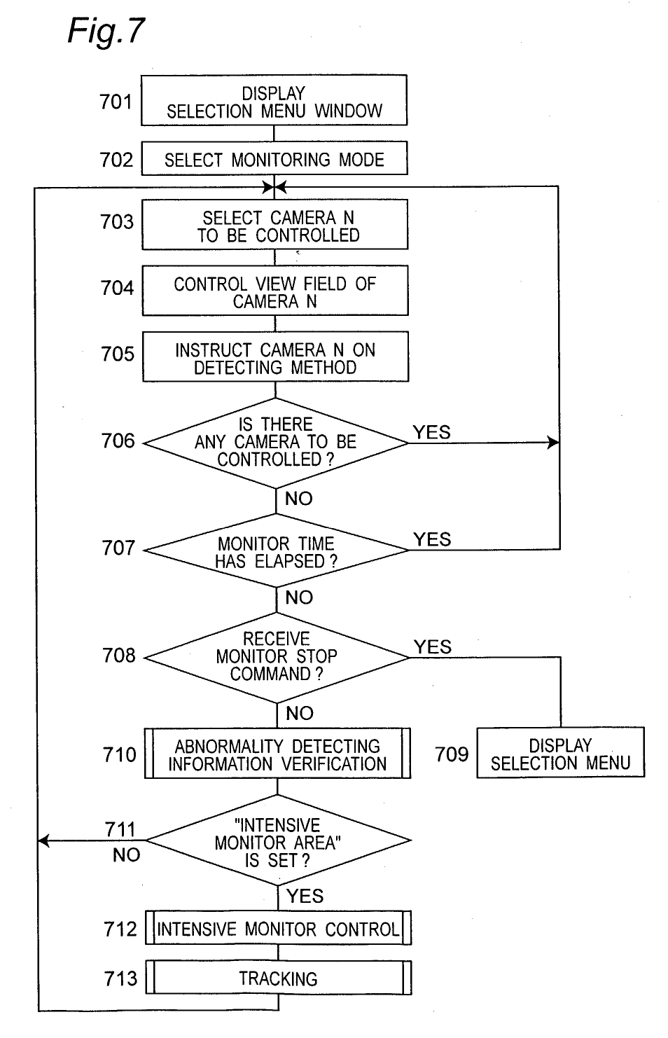

FIGS. 7-12 show a flow chart illustrating a monitoring/tracking operation performed by the monitoring system 2 according to the embodiment. Referring also to FIGS. 1, 2, 5 and 6, the system is first activated to cause the selection menu window to appear on the screen of the display device 8 (step 701). When the monitoring mode is selected from the selection menu, the images captured by the cameras 4 are displayed on the display device 8 (step 702).

The camera control section 10 selects one camera N(=4A−4D) to control its view field (step 703). As for the camera N, the camera control selection 10 checks the “circuit number” and “view field information” for each monitored area that are managed in the main management section 14, in order to control the actuator 20 of the camera N so that the camera N points at an area to be first monitored (step 704). The camera control section 10 checks the “detecting method information” for each monitored area that is managed in the main management section 14, in order to instruct the camera N on the selected detecting method (moving object or color detection) (step 705). The process at steps 703-705 is repeated until the camera control section 10 has instructed the rest of the cameras on their view fields and monitoring method(s) and the procedure moves to step 707 (step 706).

At step 707, a determination is made as to whether a monitoring period of time for a current monitored area has elapsed. If the determination is affirmative, the procedure returns to step 703, so that the view field of each camera is controlled so that it points at the next area to be monitored (steps 703-706). If the determination is negative, the procedure moves to step 708.

At step 708, a determination is made as to whether the system 2 receives a user command via the input device 9 indicative of terminating the monitoring operation. If the determination is affirmative, the selection menu window, which is an initial screen, is displayed on the display device 8 (step 709). If the determination is negative, the procedure moves to step 710.

At step 710, the camera control section 10 checks the “image/sensor abnormality detecting information” in the sub management section 24 of each camera 4.

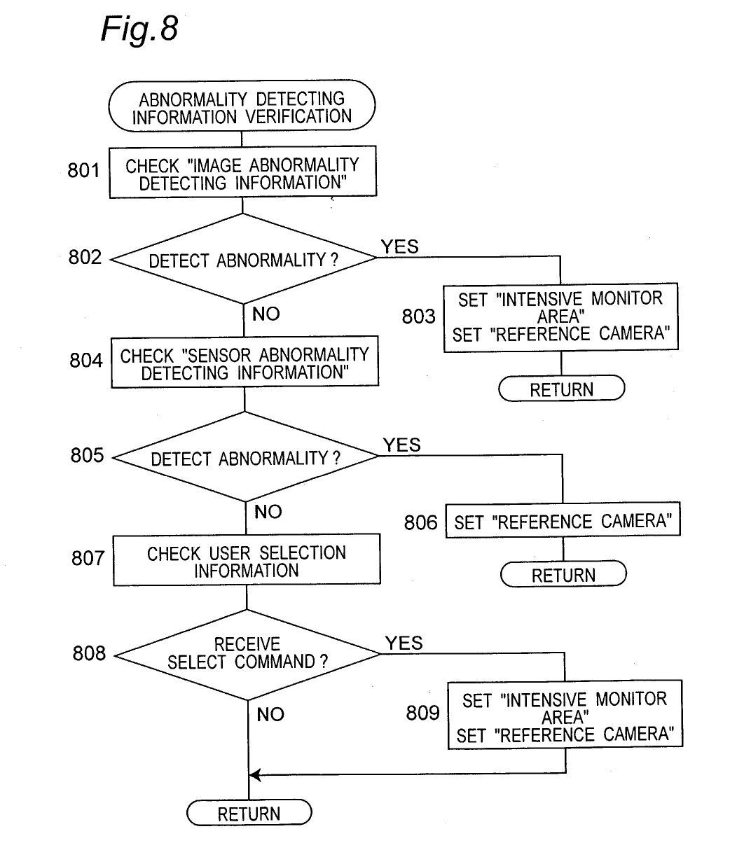

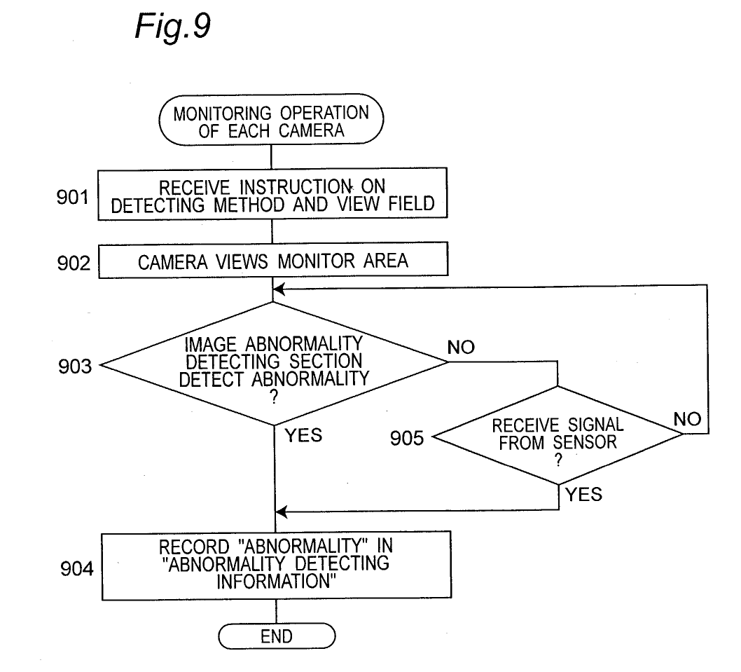

The process for checking abnormality detection information at step 710 is described in detail with reference to a subroutine of FIG. 8. Initially, the camera control section 10 checks the “image abnormality detecting information” in the sub management section 24 of each camera 4 (step 801). At step 802, a determination is made as to whether a camera 4 has detected abnormality. If the determination is affirmative, the process moves to step 803. As for step 802, the monitoring sequence of each camera will be described with reference to FIG. 9. At step 803, an area which is being pointed at by the camera that has detected abnormality is set to be an “intensive monitor area”. Also, the camera is set to be a “reference camera” and then the process is done.

If abnormality is not detected at step 802, the camera control section 10 checks the “(inside) sensor abnormality detection information” in the sub management section 24 of each camera 4 and “outside sensor abnormality detection information” in the management section 32 (step 804).

At step 805, a determination is made as to whether a sensor has detected abnormality. If the determination is affirmative, the camera control section 10 checks the information regarding the positional relationship stored in the sensor/area information storage section 16 so that the monitored area where the sensor is located is set to be an “intensive monitor area” (step 806). Thereafter the process is done.

If the determination is negative at step 805, the camera control section 10 checks the “user selection information” of each camera 4 managed in the main management section 14 (step 807).

At step 808, a determination is made as to whether the user has selected a camera 4. If the determination is affirmative, an area that is being pointed at by the selected camera 4 is set to be an “intensive monitor area” (step 809). Also, the camera is set to be a “reference camera” and then the process is done.

If the determination is negative at step 808, the process is done.

FIG. 9 shows a monitoring sequence of each camera. First, each camera 4 receives a command from the camera control section 10 instructing the camera on its view field and detecting method (step 901). The actuator 20 controls the view field within which a monitored area is viewed and the image abnormality detecting section 22 starts monitoring (step 902).

At step 903, a determination is made as to whether the image abnormality detecting section 22 of a camera 4 has detected abnormality. If the determination is affirmative, the “image abnormality detection information” in the sub management section 24 of the camera 4 is switched to “abnormality” and the monitoring process is completed (step 904). As described above, the camera control section 10 checks the “image abnormality detection information”, when necessary, in order to detect abnormality in images captured by a camera.

If the determination is negative at step 903, a determination is made as to whether a camera 4 receives a signal from the sensor located in the corresponding monitored area (step 905). If the determination is affirmative (for example, the camera 4B has received a signal from the sensor S2 in the monitored area E2.), the “sensor abnormality detection information” in the sub management section 24 of the camera 4 is switched to “abnormality” and the monitoring process is done (step 904). As described above, the camera control section 10 checks the “sensor abnormality detection information”, when necessary, in order to detect abnormality via a sensor. If the determination is negative at step 905, the procedure returns to step 903.

Referring again to FIG. 7, at step 711, a determination is made as to whether an intensive monitor area has been set at step 710. If the determination is negative, the procedure returns to step 703 so that the view field of each camera is controlled so that it views the next area to be monitored. If the determination is affirmative, a process of the intensive monitoring control is started (step 712).

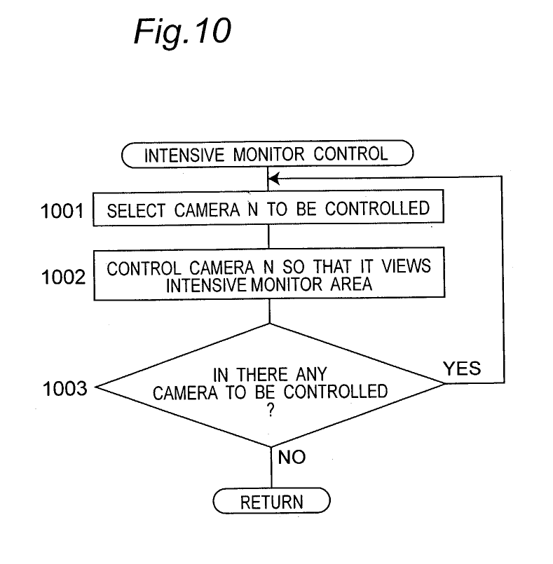

The process of the intensive monitor control at step 712 is described in detail with reference to a subroutine of FIG. 10. In the description below, it is assumed that the monitored area E4 has been set to be an “intensive monitor area”.

Initially, a camera N is selected in order to control its field of view within which the intensive monitor area E4 is viewed (step 1001). Where a “reference camera” has been set in the process of the abnormality detection information verification in FIG. 8 (i.e., abnormality has been detected based on images captured by the camera 4 or the user has selected an intensive monitor area while watching an image on the display device 8), the camera N is one of three cameras other than the reference camera. Where a “reference camera” is not set (i.e., a sensor has detected abnormality), the camera N is one of four cameras 4A-4D. However, where a camera pointing at an area in which a sensor has detected abnormality, the view field of the camera may not be controlled.

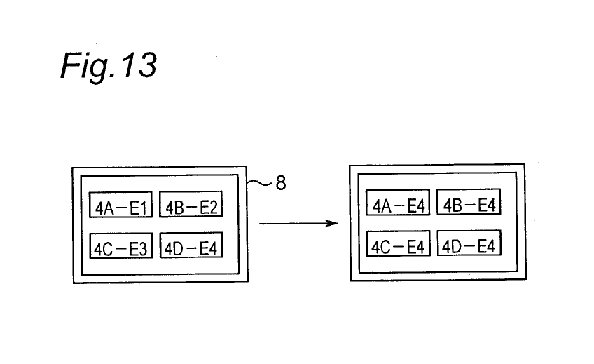

At step 1002, the camera control section 10 checks the view field information managed in the main management section 14 to instruct the actuator 20 to control the camera N so that it views the intensive monitor area E4 within its view field. The process at steps 1001 and 1002 is repeated for the rest of the cameras so that all cameras 4A-4D view the intensive monitor area E4 (step 1003). As such, a monitoring system 2 can image one area from a plurality of directions. As shown in FIG. 13, the intensive monitor area E4 is displayed on all of the display blocks of the display 8. Thereafter, the process is completed.

Referring again to FIG. 7, after the intensive monitoring control process, a tracking process with the plurality of cameras 4A-4D is started (step 713).

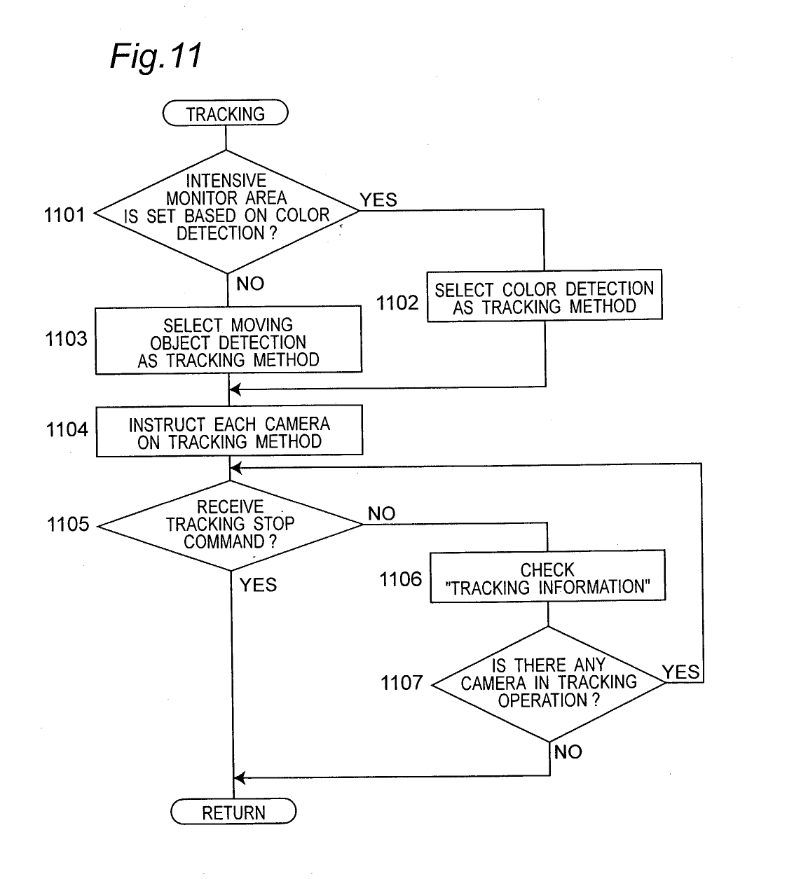

The tracking process at step 713 is described in detail with reference to a subroutine of FIG. 11. Initially, a determination is made as to whether a color detection based on images captured by the reference camera has caused the intensive monitor area E4 to be set (step 1101). If the determination is affirmative, a color detecting method is selected for tracking an object (step 1102). In other words, a color detection is selected as tracking method for the rest of the cameras. If the determination is negative (i.e., a moving object detection based on images captured by the reference camera, abnormality detection by the sensor S4 in the monitored area E4 has caused the intensive monitor area E4 to be set, or the user has selected the area E4 as intensive monitor area.), a moving object detecting method is selected for tracking an object (step 1103). In other words, a moving object detection is selected as tracking method for all of the cameras.

At step 1104, the camera control section 10 instructs each camera 4 on the tracking method selected at steps 1102 or 1103, so that it begins to track an object. At step 1105, a determination is made as to whether the camera control section 10 receives a user command indicative of terminating the tracking operation. If the determination is negative, the camera control section 10 checks the “tracking information” in the sub management section 24 of each camera to verify whether it is in the tracking operation (step 1106). If the determination is affirmative at step 1105, the tracking process is finished. Thereafter, the procedure returns to step 703 in FIG. 7 so that the cameras restart the monitoring operation.

At step 1107, a determination is made as to whether at least one of the cameras are in the tracking operation. If the determination is affirmative, the process returns to step 1105 and the at least one of the cameras continue to track an operation. If the determination is negative, the tracking process is finished.

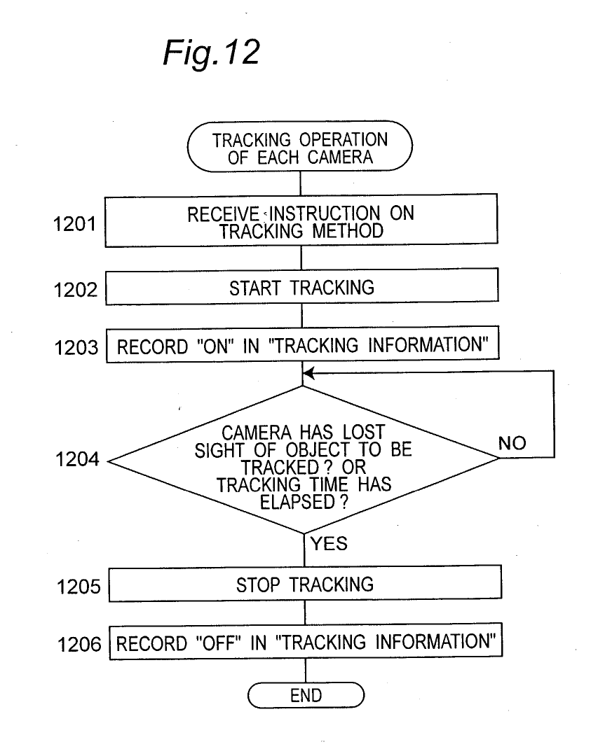

FIG. 12 shows a tracking sequence of each camera. First, each camera 4 receives a command from the camera control section 10 instructing the camera on the tracking method (step 1201), so that it starts a tracking operation (step 1202). At step 1203, the “tracking information” in the sub management section 24 of each camera 4 is switched to “ON”.

At step 1204, a determination is made as to whether the camera 4 has lost sight of an object to be tracked or abnormal object (i.e. the tracked object has moved outside of the view field.) or whether a tracking period of time stored in the time parameter storage section 18 has elapsed. If the determination is affirmative, the camera 4 stops to track the object (step 1205). Thereafter, the “tracking information” in the sub management section 24 of the camera 4 is switched to “OFF” (step 1206) and the tracking process is finished. If the determination is negative at step 1204, the camera 4 continues to track the object.

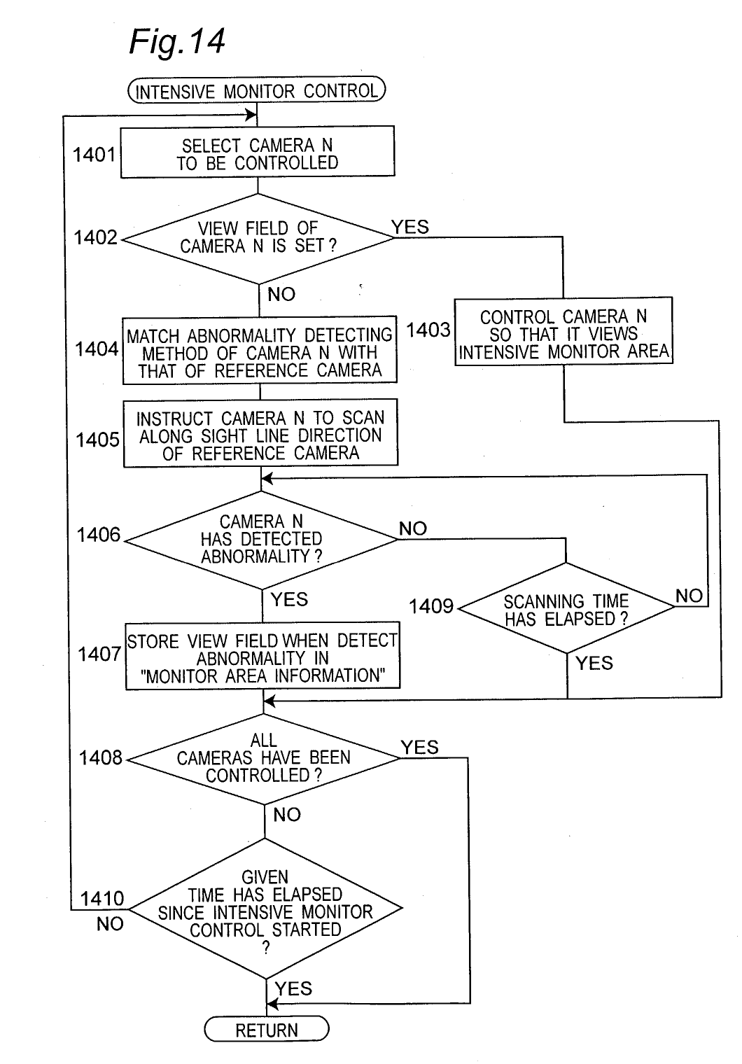

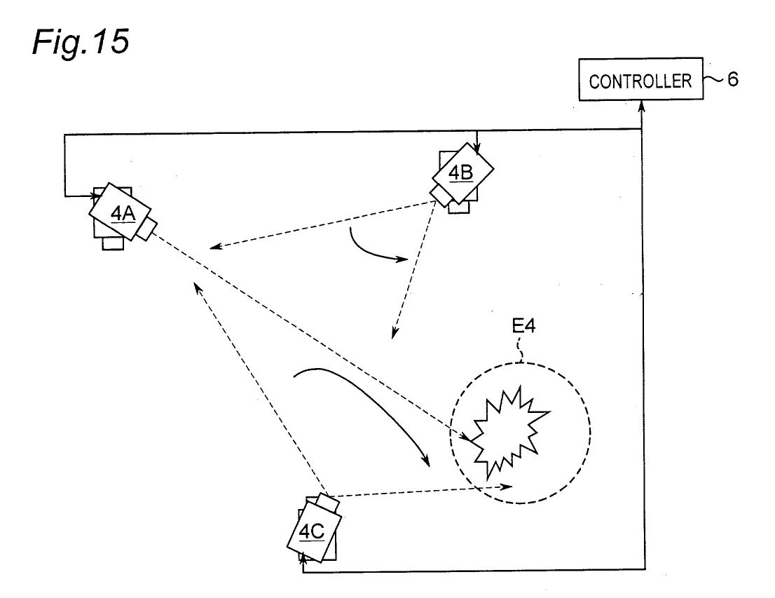

Referring now to FIGS. 14 and 15, another embodiment of the intensive monitoring control process will be described hereinafter. In this embodiment, unlike the process in FIG. 10, where a view field of a camera within which an intensive monitor area is viewed is not set (for example, the cameras 4B and 4C do not view the monitored area E4 during the circuit.), the camera is controlled so that it views the intensive monitor area. In the description below, it is assumed that the camera 4A is set to be a “reference camera” and the area E4 to be an “intensive monitor area”. Note that other components such as camera 4D are not shown in FIG. 15.

Initially, a camera N is selected in order to control its field of view within which the intensive monitor area E4 is viewed (step 1401). At step 1402, the camera control section 10 checks the information managed in the main management section 14 to determine whether a view field of the camera N is configured, within which the area E4 is to be viewed. The determination is affirmative, the camera control section 10 instructs the actuator 20 to control the camera N so that it views the intensive monitor area E4 within the view field (step 1403). Thereafter, the process moves to step 1408.

If the determination is negative at step 1402, the abnormality detecting method (color detection or moving object detection) of the camera N is set to be the same as that of the reference camera (step 1404). At step 1405, the camera control section 10, based on the locations of the camera N and reference camera 4A and view field of the reference camera 4A, instructs the camera N to scan a region along a “sight line” direction of the reference camera 4A (i.e. the optical axis of a lens system of the camera 4A).

Specifically, the camera control section 10 shifts a scanning area that the camera views within its field of view from a region near the reference camera to a region away from it. Where abnormality is not detected even if the scanning area is shifted to a region which is spaced a distance away from the reference camera 4A, the scanning area may be shifted toward a region near the reference camera 4A. Moreover, the camera N may be controlled so that its scanning area is moved back and forth several times along the sight line direction of the reference camera 4A.

At step 1406, a determination is made as to whether the camera N has detected an abnormal object while it scans a region along the sight line direction. If the determination is affirmative, a view field of the camera when abnormality was detected is stored in the “monitor. area E4 information” as for the camera N in the main management section 14 (step 1407). Thereafter, the process moves to step 1408. If the determination is negative at step 1406, a determination is made as to whether a scanning period of time has elapsed (step 1409). If the determination is affirmative, the process moves to step 1408. If the determination is negative, the process returns to step 1406.

At step 1408, a determination is made as to whether all of the cameras have been controlled so that they view the intensive monitor area E4. If the determination is negative, a determination is made as to whether a predetermined period of time has elapsed since the intensive monitor control started (step 1410). If the determination is affirmative at step 1408 (i.e., all of the cameras 4 begin to monitor the area E4.), the process of the intensive monitor control is completed.

If the determination is negative at step 1410, the process returns to step 1401 and the rest of the cameras are controlled so that they view the area E4. Note that one or more cameras that could not detect abnormality are controlled again after the rest of the cameras have been controlled so that they view the area E4. If the determination is affirmative at step 1410 (i.e., the one or more cameras could not detect an abnormality object until the predetermined period of time has elapsed since the intensive monitor control started.), the process of the intensive monitor control is finished. Thereafter, the cameras other than the one or more cameras perform a tracking operation.

In the flow chart in FIG. 14, where a camera is set to be a “reference camera” (i.e., abnormality has been detected based on images captured by a camera 4 or the user has selected an intensive monitor area while watching the display device 8.), the other cameras scan a region along the sight line direction of the reference camera, so that the other cameras detect abnormality. On the other hand, where a sensor detects abnormality, a “reference camera” is not set. In this case, one or more cameras that view a monitored area during the circuit where the sensor is located are controlled so that they view the monitored area. Then, other cameras that do not view the monitored area during the circuit are controlled so that they scan a region along a sight line of one of the cameras that has been controlled so that it views the monitored area.

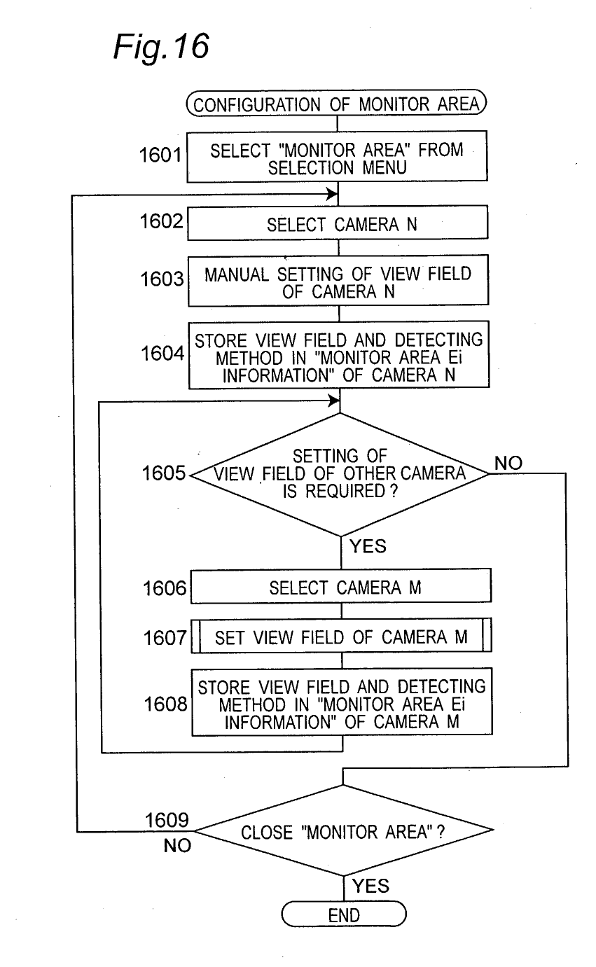

With reference to FIGS. 16-25, a configuration or setting mode will now be described. When a user selects a configuration mode on a selection menu window (see FIGS. 3A and 3B) displayed on the display device 8 upon a start-up of the system, the configuration mode window appears that allows various parameters of the system to be set. The user can select one of the menus “Monitor Area”, “Circuit Order”, “Monitor Time Parameter” and “Detection Color”.

With reference to FIG. 16, a configuration method for setting an area to be monitored will be described. As described above, in the “Monitor Area” menu, the user selects any location as a monitored area and sets a field of view of each camera 4 so that the camera can capture an image of the area.

First, a user selects the “Monitor Area” menu on the selection menu window (step 1601). The user selects a camera N(=4A−4D) for which the monitored area is to be set (step 1602). The user sets a view field of the camera N via the input device 9 (i.e., manually) so that the camera views an area to be monitored (step 1603). The current view field and the detecting method (moving object detection or color detection) are stored as “monitor area Ei information” as for the camera N in the main management section 14 (step 1604). Also, information on a positional relationship between the monitored area Ei and a sensor located in the area is stored in the sensor/area information storage section 16.

At step 1605, a determination is made as to whether other camera(s) are to be configured to view the monitored area Ei. If the determination is affirmative, other camera M is selected for the configuration (step 1606). At step 1607, the camera M is configured so that it views the monitored area Ei within a view field.

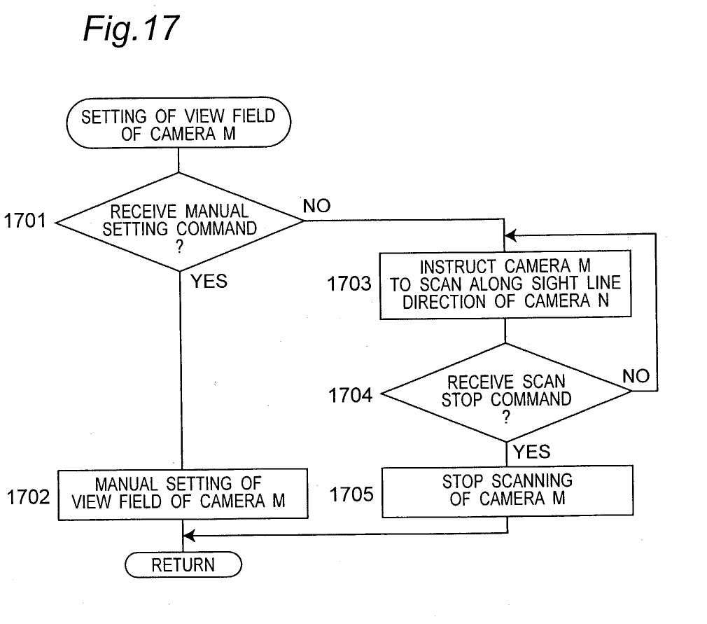

More specifically, referring to a subroutine of FIG. 17, with regard to a camera which is to be configured after one or more cameras have been configured, its field of view may be either manually or automatically adjusted.

At step 1701, a determination is made as to whether the user selects a manual adjustment for the configuration of the view field of the camera M. If the determination is affirmative, the user sets a view field of the camera M via the input device 9 so that the camera M views the monitored area Ei (step 1702).

If the determination is negative at step 1701, the camera control section 10, based on the locations of the cameras M and N and orientation information (pan/tilt angles) of the camera N, instructs the camera M to scan a region along a sight line direction of the camera N (step 1703). The user watches the display 8 and instructs the camera control section 10 to stop scanning if the camera M view the monitored area Ei within a view field (steps 1704 and 1705). If necessary, a field of view of the camera M may be finely adjusted with a manual operation.

Returning to FIG. 16, at step 1608 the current view field of the camera M is stored in the “monitored area Ei information” in the main management section 14. Thereafter, the process returns to step 1605.

If the determination is negative at step 1605, a determination is made as to whether the “Monitor Area” menu is closed (step 1609). If the determination is negative, the process returns to step 1602. Then, with regard to other area(s) to be monitored, the cameras are configured to view the area(s).

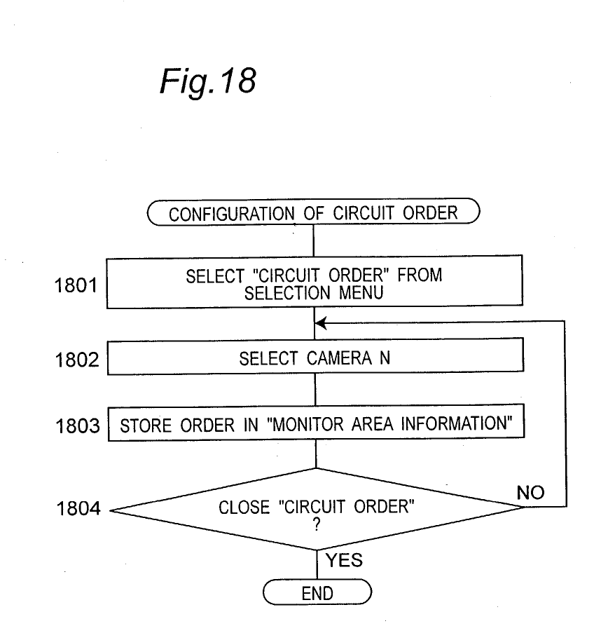

Next, with reference to FIG. 18, a configuration method for setting an order in which a camera points at a plurality of monitored areas during a circuit will be described.

First, a user selects the “Circuit Order” menu on the selection menu window (step 1801). The user selects a camera N(=4A−4D) for which the order is to be set (step 1802). The user sets an order in which the camera N make the circuit of the plurality of monitored areas that have been set in the “Monitor Area” menu, and the order is stored in the “monitor area information” in the main management section 14 (step 1803). If the “Circuit Order” menu is not closed at step 1804, the process returns to step 1802. Then, circuit orders are specified for the other cameras.

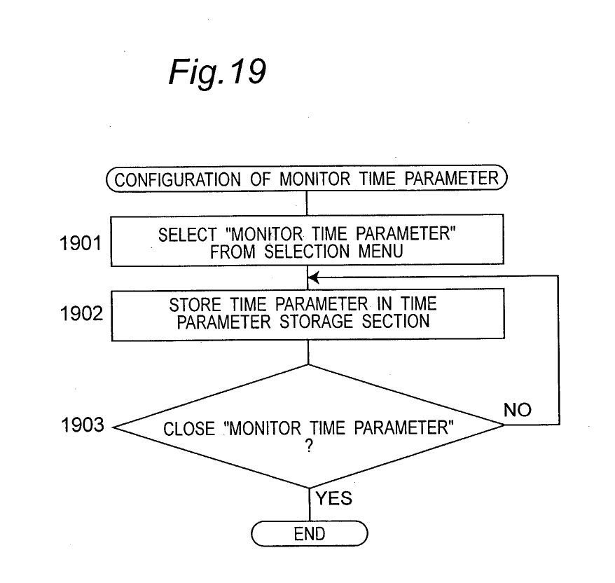

Next, with reference to FIG. 19, a configuration method for setting a time parameter indicating how long each camera monitors each monitored area.

First, a user selects the “Monitor Time Parameter” menu on the selection menu window (step 1901). The user sets a time parameter and it is stored in the time parameter storage section 18 (step 1902). If the “Monitor Time Parameter” menu is not closed at step 1903, the process returns to step 1902 so that the parameter can be adjusted. The time parameter may be different for different cameras and/or monitored areas.

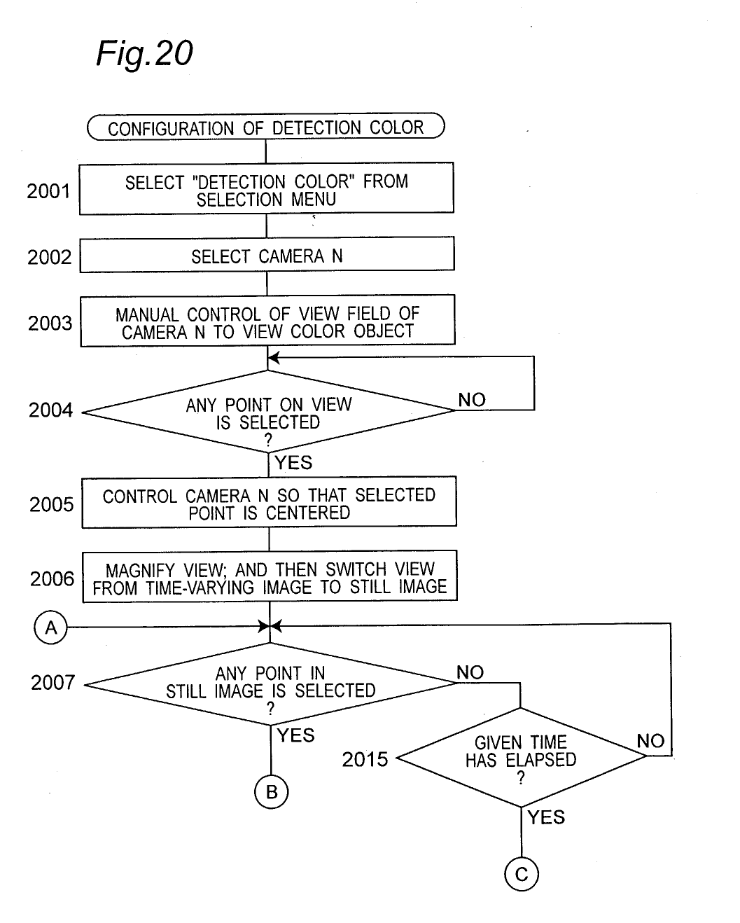

Next, with reference FIGS. 20-22, a configuration method for setting a detection color will be described. In the description below, it is assumed that a color of a child's clothes is to be set as detection color.

First, a user selects the “Detection Color” menu on the selection menu window (step 2001). The user selects a camera N(=4A−4D) via the input device 9 with which the detection color is to be set, so that time-varying image captured by the selected camera N is displayed on the display device 8 (step 2002). The user controls a view field of the selected camera N via the input device 9 so that it views clothes of a child, which is referred to as color object (step 2003).

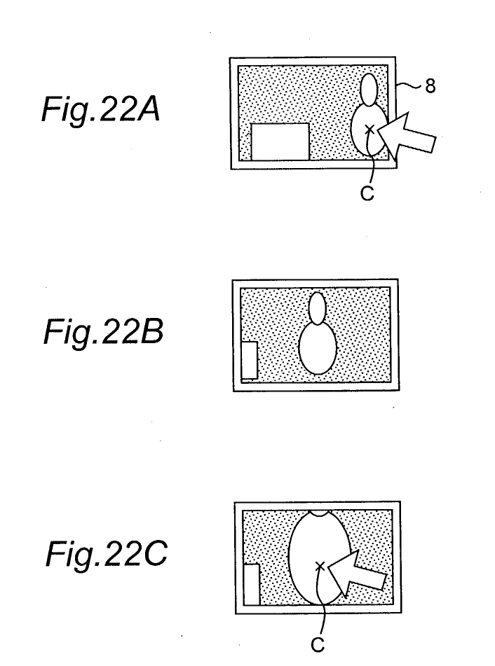

At step 2004, a determination is made as to whether the user selects any point on the view with a cursor C. If the determination is affirmative (see FIG. 22A), the camera control section 10 controls the selected camera N so that the selected point is located at the center of the view field as shown in FIG. 22B (step 2005). The reason why the camera N is controlled so that the color object is located in a generally central region of the view is that the color object is not outside the view when it is magnified at step 2006.

At step 2006, the camera control section 10 magnifies the view so that it is centered about the selected point (see FIG. 22C). Then, the image processing section 12 causes the view on the display device 8 to be switched from a time-varying image to a still image. Thus, by displaying a still image, the user can easily specify a detection color. Also, the magnification of the view allows the user to specify a detection color with more ease.

At step 2007, a determination is made as to whether any point is selected in the still image. If a portion of a child's clothes is selected with the cursor C in the still image, the image processing section 12 sets a color of pixels of a selected point and the periphery thereof (which are referred to as peripheral pixels) together with a color approximate to the color of the peripheral pixels as pre-specified color and causes it to be temporarily stored in the detection color storage section 34 (steps 2008 and 2009). Thus, by adding a width or “fudge factor” to a color selected with a cursor, if a child's clothes does not have a monotone color, the clothes as a whole can be set as color object.

At step 2010, the image processing section 12 causes a portion having a pre-specified color (which consists of a color of the selected point and the periphery thereof and the approximate color) around the point selected in the still image to blink or flash. At step 2011, a determination is made as to whether the system 2 receives a user command via the input device 9 allowing the pre-specified color of the blinking portion to be set as detection color. If the determination is affirmative, the specified color data temporarily stored in the detection color storage section 34 is stored as detection color data (step 2012). As described above, the camera control section 10 checks the detection color data in the monitoring/tracking operation.

At step 2013, the image processing section 12 returns the magnification increased at step 2006 to 100%. Thereafter, it switches a view on the display 8 from the still image to a time-varying image (step 2014). Then, the process is completed.

If the determination is negative at step 2007, a determination is made as to whether a predetermined period of time has elapsed since a view was switched to the still image (step 2015). If the determination is affirmative, the process moves to step 2013 in which the magnification is returned to 100% and a time-varying image is displayed.

If the determination is negative at step 2011, i.e., the system 2 receives a user command via the input device 9 allowing the setting of the pre-specified color of the blinking portion to be cancelled, the process returns to step 2007 in which the still image is displayed while the system 2 waits for a user command instructing a point in the still image.

As such, a detection color is associated with data of a still image captured by a camera. Accordingly, by making use of the data, an object which shows up in an image captured by other camera(s) can also be detected.

With the detection color configuration method described above, a background object having a detection color as well as a color object could be detected. However, a combination of color and moving object detection methods allows only a moving object having a detection color to be monitored.

Note that although the information regarding an object to be monitored is preferably color, the present invention is not limited to the kind of information. For example, it is possible to specify a person's face as an object to be detected, by means of a technology known as face recognition.

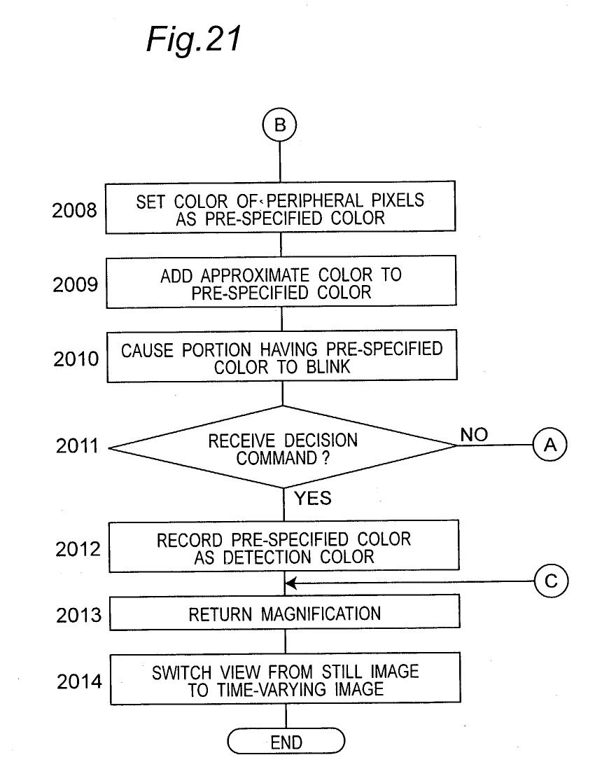

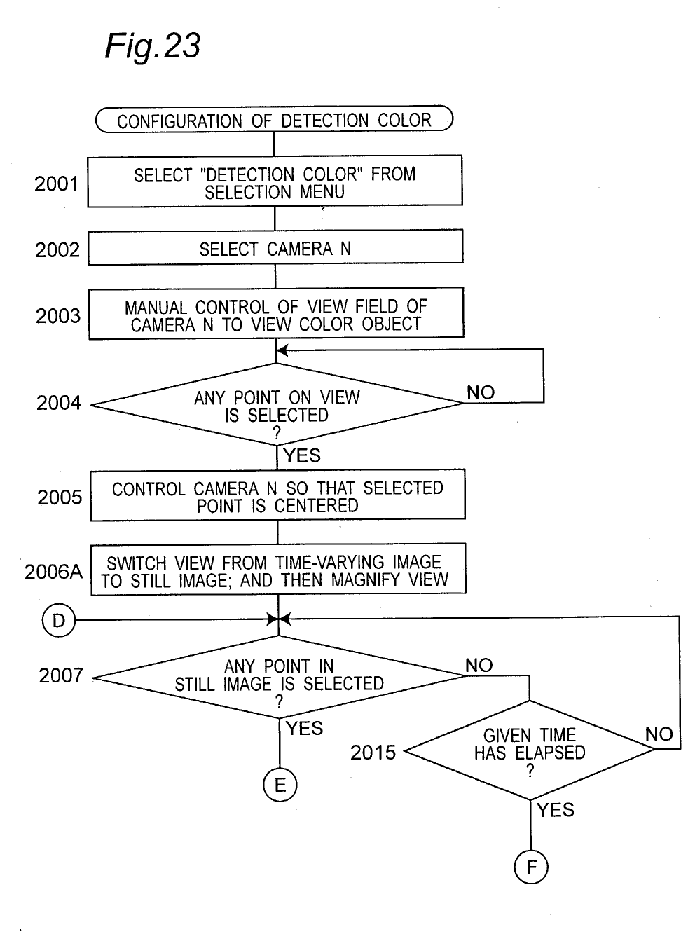

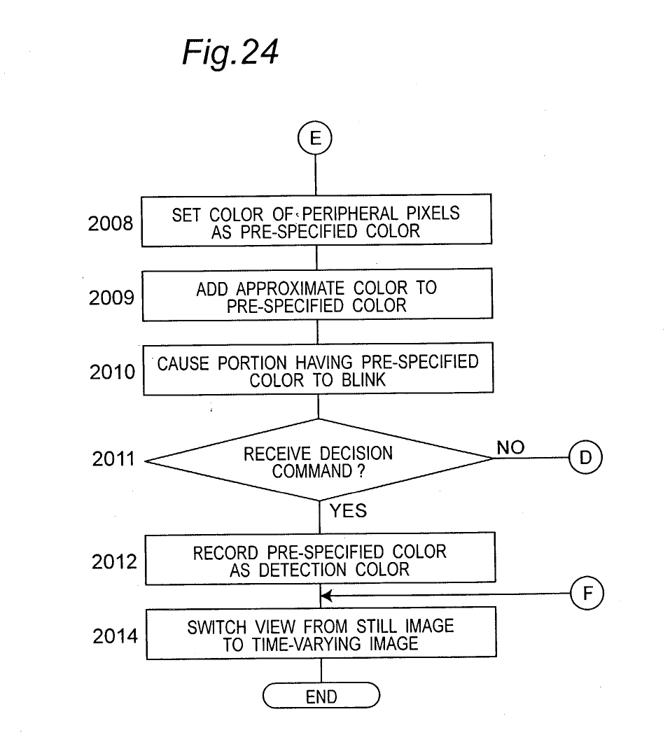

FIGS. 23 and 24 show a flow chart illustrating a variant of the configuration method for setting a detection color shown in FIGS. 20 and 21. At step 2006 in FIG. 20, after the camera control unit 10 controls a selected camera to magnify an image on the display device 8 so that it is centered about a selected point, the image processing section 12 switches the view from a time-varying image to a still image. In the flow chart in FIGS. 23 and 24, at step 2006A, after the image processing section 12 switches a view on the display 8 from a time-varying image to a still image, it extracts data of a still image centered about a selected point and magnifies the still image. In this case, unlike at step 2013 in FIG. 21, the camera control section 10 does not return the magnification to 100%. Accordingly, after a detection color data is stored in the detection color storage section 34 at step 2012, the process moves to step 2014 in which a view on the display 8 is switched from the still image to a time-varying image.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

For example, although in the previous embodiment each camera makes the circuit of the plurality of monitored areas in a monitoring operation, each camera may always monitor its respective fixed area in a normal monitoring operation and all cameras are controlled so that they view an intensive monitor area if abnormality has been detected.

Also, although in the previous embodiment the sensors S1-S6 are located in all the areas E1-E6, a sensor may not necessarily be located in an area such as E1-E4 which a camera captures an image of during the circuit.

Further, the image abnormality detecting section 22 and sub management section 24 may be incorporated in the computer 6 instead of in the camera 4. In other words, a program for operating, for example, an image abnormality detection may be installed on the computer 6.

In addition, although in the previous embodiment the selection menu window provides the monitoring and configuration modes so that a user can select either of them, the system may receive, in the monitoring mode, a user command instructing the system on a color to be detected, so that the cameras are controlled so that they perform monitoring and/or tracking operations based on the detection color.

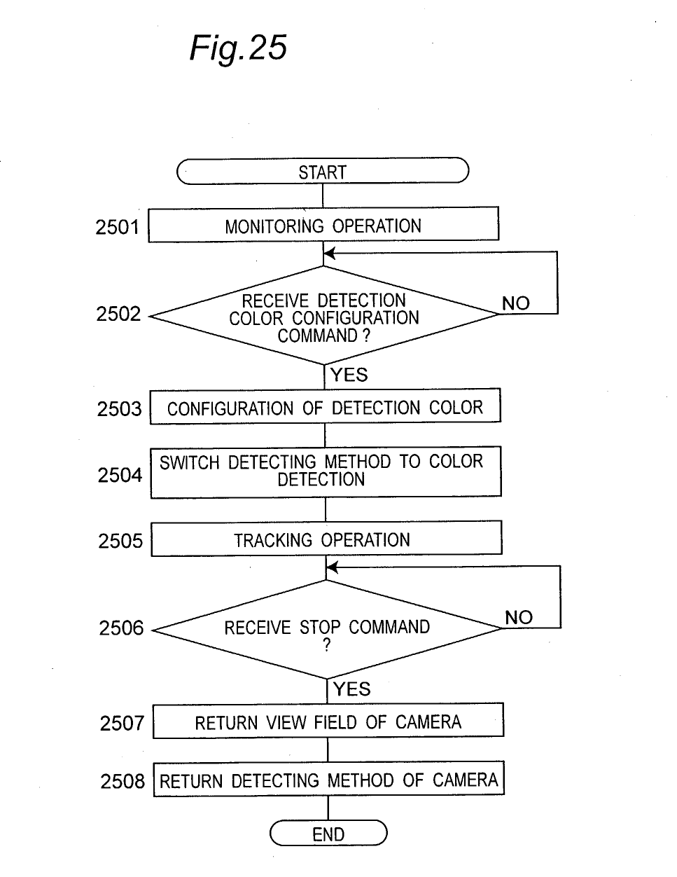

FIG. 25 shows a flow chart illustrating a process for setting a detection color during a circuit so that the cameras perform a monitoring/tracking operation based on the detection color. Referring also to FIG. 2, while the cameras 4 are in a monitoring operation at step 2501 (see steps 703-711 in FIG. 7), the camera control section 10 can receive a user command allowing the user to configure a detection color (step 2502). A detection color is specified (step 2503) in a similar method to, for example, that described in FIGS. 20-22. The information on the detection color is stored in the detection color storage section 34.

At step 2504, the camera control section 10 switches a surveillance or detecting method of each camera 4 to a color detection. At step 2505, each camera, based on the information in the detection color storage section 34, begins to track an object (e.g. clothes of a child) having the detection color when it views the object within its field of view. When the object moves outside of the view field, the camera stops the tracking operation.

At step 2506, a determination is made as to whether the system 2 receives a user command indicative of terminating the tracking operation based on the detection color set at step 2503. If the determination is affirmative, the process moves to step 2507 in which the camera control section 10 switches a view field of each camera back to a view field for a normal monitoring operation. Then, at step 2508, the camera control section 10 switches a surveillance or detecting method of each camera back to a method for a normal monitoring operation. Thereafter, the process is finished.

In the flow chart, the system 2 resumes the “normal” monitoring operation only in case it receives a stop command from the user. However, the system 2 may be configured so that, when a predetermined period of time has elapsed since the cameras began to perform a color monitoring operation based on a detection color (in other words, since a detection color was specified.), the system 2 resumes the normal monitoring operation.

What is claimed is:

1. A monitoring system comprising:
first and second cameras for capturing an image of first and second areas, respectively;
first and second detectors for detecting an object to be monitored or abnormality in the first and second areas, respectively; and
a controller for controlling view fields of the first and second cameras, wherein, when the second detector detects the object or abnormality in the second area, the first camera is controlled so that it views the second area within its view field, and, when the first detector detects the object or abnormality in the first area, the second camera is controlled so that it views the first area within its view field.

2. A system in accordance with claim 1, wherein the first and second detectors detect the object or abnormality in the first and second areas based on images captured by the first and second cameras, respectively.

3. A system in accordance with claim 2, wherein, when the object or abnormality is detected in the second area, the first camera is controlled so that it views a region along a sight line direction of the second camera, so that the first camera views the object or abnormality in the second area within its view field.

4. A system in accordance with claim 1, wherein the first and second detectors are a sensor located in the first and second areas, respectively.

5. A system in accordance with claim 1, wherein, when the first and second cameras capture an image of the object in one of the first and second areas where the object has been detected, the controller controls the first and second cameras so that they track the object.

6. A computer program for controlling a monitoring system comprising first and second cameras for capturing an image of first and second areas, respectively; and first and second detectors for detecting an object or abnormality in the first and second areas, respectively, the computer program including instructions for causing a computer to implement a method comprising:
controlling the first camera so that it views the second area within its view field when the second detector detects the object or abnormality in the second area; and
controlling the second camera so that it views the first area within its view field when the first detector detects the object or abnormality in the first area.

7. A monitoring system comprising:
a first camera;
a display device for displaying a time-varying image captured by the camera;
a switching section for switching a view on the display device from the time-varying image to a still image in response to a user command;
a storage section for storing information regarding an object to be monitored, the object being selected by pointing at the object in the still image on the display device; and
a detecting section for detecting the object in an image captured by the camera, based on the image and the information regarding the object to be monitored which is stored in the storage section.

8. A system in accordance with claim 7, wherein the information regarding the object to be monitored is color information.

9. A system in accordance with claim 7, wherein the information regarding the object to be monitored is information on a person's face.

10. A system in accordance with claim 7, wherein the detecting section detects the object in a time-varying image captured by the camera.

11. A system in accordance with claim 7, wherein the detecting section detects the object in a still image captured by the camera.

12. A system in accordance with claim 7, further comprising a second camera, wherein the display device displays a time-varying image captured by at least one of the first and second cameras; and
wherein the detecting section detects the object in images captured by the first and second cameras, based on the images and the information regarding the object to be monitored which is stored in the storage section.

13. A computer program for controlling a monitoring system comprising a first camera and a display device for displaying a time-varying image captured by the camera; the computer program including instructions for causing a computer to implement a method comprising:
switching a view on the display device from the time-varying image to a still image in response to a user command;
storing information regarding an object to be monitored, the object being selected by pointing at the object in the still image on the display device; and
detecting the object in an image captured by the camera, based on the image and the information regarding the object to be monitored.

14. A computer program in accordance with claim 13, wherein the monitoring system further comprising a second cameras; wherein the display device displays a time-varying image captured by at least one of the first and second cameras; and wherein the object in images captured by the first and second cameras is detected, based on the images and the information regarding the object to be monitored.
